(19) United States
(12) Patent Application Publication
(10) Pub. No.: US 2010/0002068 A1
(43) Pub. Date: Jan. 7, 2010

(54) COMMUNICATION TERMINAL AND METHOD FOR PERFORMING VIDEO TELEPHONY

(75) Inventor: Jeong Hoon KIM, Gumi-si (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/493,384

(22) Filed: Jun. 29, 2009

(30) Foreign Application Priority Data
Jul. 4, 2008 (KR) 10-2008-0064715

(51) Int. Cl. H04N 7/14

(52) U.S. Cl. 348/14.02; 348/E07.078

(57) ABSTRACT

A communications terminal and method for performing a video telephony are provided. In the video telephony method, a selected text file is converted into a text image when selecting the text file in the video telephony and the text image is transmitted as video data. According to the present invention, the communications terminal can send and receive the text image converted from the text file as video data. Accordingly, because the text image is received as video data, the communications terminal does not need to perform an additional operation for displaying the text file during video telephony. Thus, the text image received in the communications terminal can be readily displayed.

### PRIORITY

This application claims the benefit under 35 U.S.C. §119(a) to a Korean patent application filed in the Korean Intellectual Property Office on Jul. 4, 2008 and assigned Serial No. 10-2008-0064715, the entire disclosure of which is hereby incorporated by reference.

### BACKGROUND OF THE INVENTION

1. Field of the Invention

The present invention relates to a communications terminal and method for performing video telephony. More particularly, the present invention relates to a communications terminal and method for performing a video telephony in which video data and audio data are sent and received.

2. Description of the Related Art

With advances in communications technology, a conventional communications terminal provides various functions beyond the basic calling function. For example, the conventional communications terminal may provide various functions including a camera function, a message transmission function, a memo management function, an MP3 function, and a wireless internet function.

Furthermore, the conventional communications terminal provides a video telephony function. When performing the video telephony, the communications terminal sends and receives video data on a real time basis, and displays the transceived video data. At this time, the video telephony function of the communications terminal can be classified into a circuit switching system using a switch and a packet switching system using an All Internet Protocol (All-IP) network. Such a video telephony function is performed using the H.323 or the H.324M Mobile protocol, which are international standards defined by the International Telecommunication Union (ITU) and are implemented in a mobile communications system. Here, the H.323 protocol is a system protocol enabling video telephony in the IP network which is a packet data network. The H.324 protocol is a system protocol developed based on the public network, while the H.324M protocol is an evolution of the H.324 protocol to address mobile communication.

In video telephony, the communications terminal transmits a user image, photographed through a camera or stored in advance, as video data and transmits a text file independently of the video data, when sharing the text file during video telephony. For example, the communications terminal transmits the user image for the video telephony, while transmitting the text file having a form similar to a multimedia message. Accordingly, there is a problem in that the communications terminal must perform an additional operation to display the received text file during the video telephony.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for performing video telephony in which video data and audio data are sent and received.

In accordance with an aspect of the present invention, a method of performing video telephony is provided. The method includes converting a selected text file into a text image when selecting the text file during video telephony and transmitting the text image as video data.

In accordance with another aspect of the present invention, a communications terminal is provided. The communications terminal includes a wireless communications unit for transmitting video data during video telephony, a controller for converting a selected text file into a text image when selecting the text file during the video telephony, and for transmitting the text image as video data and a memory for storing the text file.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a flowchart illustrating a signal flow for video telephony between communications terminals according to an exemplary embodiment of the present invention;

FIG. 2 is a block diagram illustrating an internal configuration of a communications terminal according to an exemplary embodiment of the present invention;

FIG. 3 is a block diagram illustrating an internal configuration of a controller according to an exemplary embodiment of the present invention;

FIG. 4 is a flowchart illustrating a video telephony procedure of a communications terminal according to an exemplary embodiment of the present invention;

FIG. 5 is a flowchart illustrating a text image conversion procedure according to an exemplary embodiment of the present invention;

FIG. 6 is a flowchart illustrating a text image transmission procedure according to an exemplary embodiment of the present invention; and

FIGS. 7A to 7F are diagrams illustrating a screen displayed during execution of a video telephony procedure according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness to avoid obscuring the subject matter of the present invention.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

As used herein, the term “text file” denotes data which include text in a communications terminal. Such a text file can be generated in the communications terminal itself through various functions of the communications terminal or can be downloaded from an external source. As an example, the text file can be individual data such as an e-mail, which is made of text, and can be data such as an MP3 file list which includes a list of file names made of text.

The term “text image” denotes an image converted from a specific text file in the communications terminal. The term “video data” denotes a video signal transceived during video telephony in the communications terminal. As an example, this video data may include an image which represents the user of the communications terminal performing the video telephony. As another example, the video data can be an image which is photographed on a real time basis through a camera in the communications terminal or can be an image photographed in advance through the camera in the communications terminal or an image stored in advance after being downloaded from an external source.

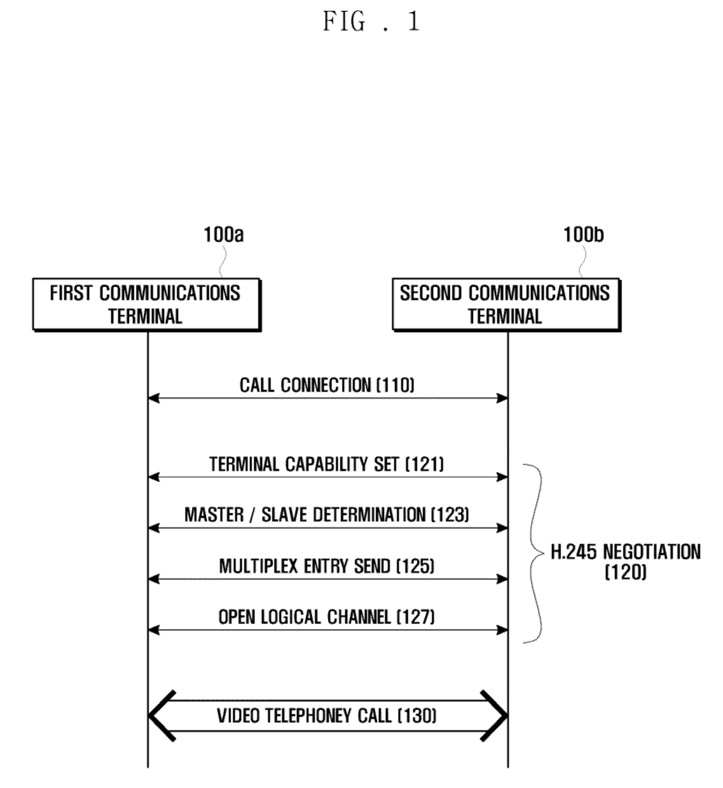

FIG. 1 is a flowchart illustrating a signal flow for video telephony between communications terminals according to an exemplary embodiment of the present invention.

Referring to FIG. 1, a first communications terminal 100a and a second communications terminal 100b perform a call connection in step 110. For example, when video telephony is desired, the first communications terminal 100a transmits a call connection request message (CONNECT REQUEST message). Upon receiving the call connection request message, the second communications terminal 100b can transmit a call connection accept message (CONNECTED ACK message). After the first communications terminal 100a receives the call connection accept message, the call is connected between the first communications terminal 100a and the second communications terminal 100b.

The first communications terminal 100a and the second communications terminal 100b perform a control information negotiation (e.g. an H.245 NEGOTIATION) through the connected call in step 120. For example, the first communications terminal 100a and the second communications terminal 100b exchange a TERMINAL CAPABILITY SET message, and set the processing capabilities of video data and audio data in step 121. For example, each of the first communications terminal 100a and the second communications terminal 100b determines and sets the display standard used by the other terminal. In particular, the first communications terminal 100a and the second communications terminal 100b set the processing capability of transceiving a text image as video data.

In step 123, the first communications terminal 100a and the second communications terminal 100b exchange a MASTER/SLAVE DETERMINATION message, and determine a master terminal and a slave terminal. In step 125, the first communications terminal 100a and the second communications terminal 100b exchange a MULTIPLEX ENTRY SEND message, and send a multiplex entry. In step 127, the first communications terminal 100a and the second communications terminal 100b exchange an OPEN LOGICAL CHANNEL message, and generate a logical channel for the transceiving of audio data and video data.

By using the control information negotiated at step 120, the first communications terminal 100a and the second communications terminal 100b perform video telephony in step 130. During the performance of video telephony, the first communications terminal 100a and the second communications terminal 100b transceive audio data and video data. In particular, the first communications terminal 100a and the second communications terminal 100b can transceive the text image as video data.

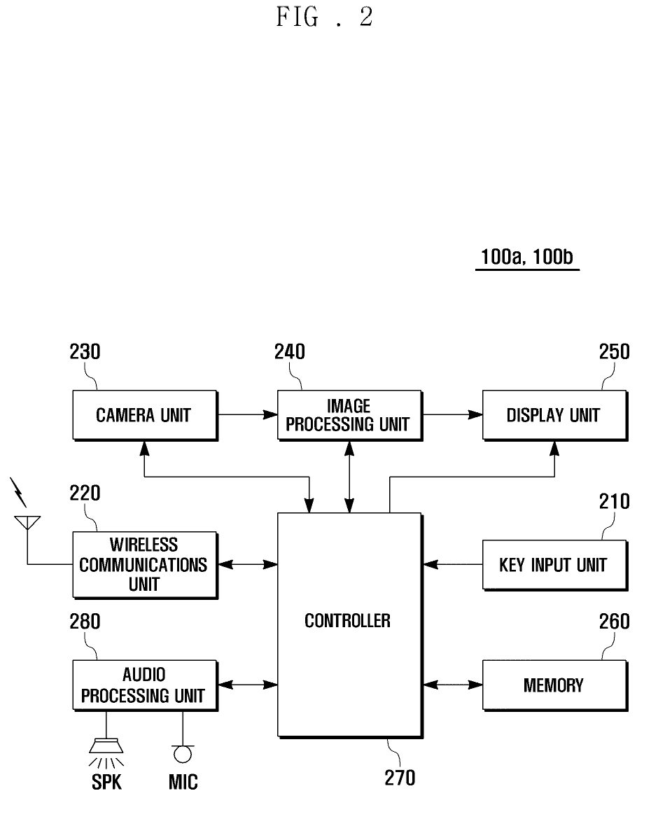

FIG. 2 is a block diagram illustrating an internal configuration of a communications terminal according to an exemplary embodiment of the present invention. In the illustrated example, it is assumed that the communications terminals 100a and 100b are mobile phones.

Referring to FIG. 2, each of the communications terminals 100a, 100b includes a key input unit 210, a wireless communications unit 220, a camera unit 230, an image processing unit 240, a display unit 250, memory 260, a controller 270 and an audio processing unit 280. The key input unit 210 includes keys for inputting number and character information and function keys for setting various functions. The wireless communications unit 220 performs the radio communications function of the communications terminal 100a, 100b. This wireless communications unit 220 includes a Radio Frequency (RF) transmitter which up-converts and amplifies the frequency of a transmitted signal, and an RF receiver which low-noise amplifies and down-converts the frequency of the received signal. More particularly, the wireless communications unit 220 transceives video data and audio data for performing video telephony. The camera unit 230 performs the function of photographing the video data for the video telephony. This camera unit 230 includes a camera sensor which converts a photographed optical signal into an electrical signal, and a signal processing unit which converts an analog image signal output from the camera sensor into a digital image signal.

In an exemplary embodiment, the camera sensor is a Charge Coupled Device (CCD) sensor, and the signal processing unit can be implemented with a Digital Signal Processor (DSP). In various exemplary implementations, the camera sensor and the signal processing unit can be integrated or can be separated.

The image processing unit 240 performs the function of displaying video data. The image processing unit 240 processes the video data in a frame unit, and outputs the data which may include adjusting the video data to the characteristics and size of the display unit 250. Moreover, the image processing unit 240 includes a video codec, and compresses the video data displayed on the display unit 250 with a set mode, or restores the compacted video data into original video data. Here, the video codec encodes the digital video data according to the H.261 or H.263 protocol. The H.261 protocol is a standard of a video phone and coded system for video conferencing and the H.263 protocol is a standard of a coded system having improvements beyond the H.261 protocol.

The display unit 250 displays the video data output from the image processing unit 240 to a screen, and displays user data output from the controller 270. The display unit 250 may include a Liquid Crystal Display (LCD) and, in this case, the display unit 250 can include an LCD controller, a memory for storing video data and an LCD display unit. In an exemplary implementation, the LCD may be implemented with a touch screen and thus can also be operated as an input unit. The memory 260 may include a program memory and a data memory. The program memory stores programs for controlling general operations of the communications terminal. More particularly, the program memory can store programs used for performing video telephony. The data memory performs the function of storing data which are generated during the performing of programs. In an exemplary implementation, the memory 260 stores a plurality of text files. The controller 270 performs the function of controlling operations of the communications terminal. The controller 270 includes a data processing unit including a transmitter which encodes and modulates a transmitted signal and a receiver which decodes and demodulates a received signal. Also, the data processing unit may include a modem and a codec. Here, the codec includes a video codec which processes video data and an audio codec which processes audio data such as a voice.

The controller 270 controls to transceive video data and audio data during video telephony. The controller 270 also controls to display received video data and controls to transmit video data to anther communications terminal. In an exemplary implementation, the controller 270 may control to transmit a user image as video data. That is, the controller 270 can transmit video data photographed through the camera unit 230 or stored in advance in the memory 260. When a text file is selected during video telephony, the controller 270 controls to convert the selected text file into a text image. In an exemplary implementation, the controller 270 can divide the text image into two or more pages. More particularly, according to the display standard which is set at step 121 of FIG. 1, the controller 270 can divide the text image. Moreover, the controller 270 can transmit the text image as video data.

The audio processing unit 280 regenerates received audio data output from the audio codec of data processing unit through a speaker (SPK), or transmits transmission audio data generated in a microphone (MIC) to the audio codec of data processing unit.

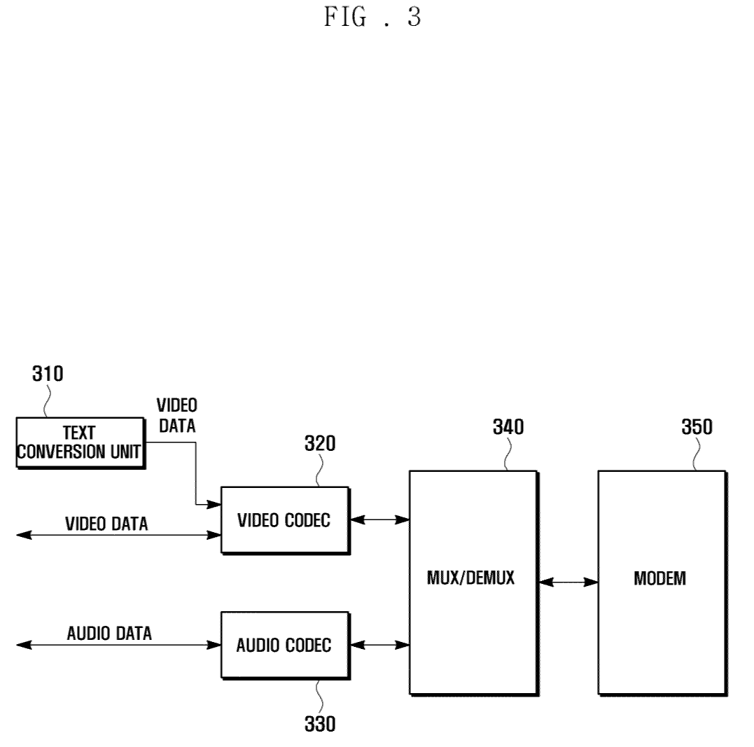

FIG. 3 is a block diagram illustrating an internal configuration of a controller according to an exemplary embodiment of the present invention.

Referring to FIG. 3, the controller includes a text conversion unit 310, a video codec 320, an audio codec 330, a Multiplexer/De-multiplexer (MUX/DEMUX) 340 and a Modulator/Demodulator (MODEM) 350.

The text conversion unit 310 converts a text file into a text image. That is, the text conversion unit 310 converts a selected text file into the text image, when selecting the text file during video telephony. The text conversion unit 310 can divide the text image into two or more pages. That is, the text conversion unit 310 can divide the text image according to the display standard which is set at step 121 of FIG. 1. Moreover, the text conversion unit 310 may individually transmit pages. The video codec 320 performs a function of encoding and decoding video data. That is, the video codec 320 encodes video data received through the wireless communications unit 220 and decodes video data for transmitting through the wireless communications unit 220.

For example, the video codec 320 decodes video data photographed through the camera unit 230 and, in particular, decodes text image output from the text conversion unit 310. In an exemplary implementation, the video codec 320 encodes and decodes video data according to the H.261, H.263 or the Moving Picture Experts Group-4 (MPEG-4) protocol. The H.261 protocol is a standard of coding and decoding for a video phone and a video conference, and the H.263 and MPEG-4 protocols are standards of coding and decoding having improvements beyond the H.261 protocol. The audio codec 330 performs the function of encoding and decoding audio data. This audio codec 330 encodes audio data received through the wireless communications unit 220 and decodes audio data received through the audio processing unit 280. In an exemplary implementation, the audio codec 330 encodes and decodes the audio data according to the Adaptive MultiRate (AMR) protocol or the G.723.1 protocol. Furthermore, the audio codec 330 can adjust the delay of the video data by making an arbitrary delay to the reception path of the audio data for the synchronization of video data and audio data.

The MUX/DEMUX 340 performs the functions of multiplexing the video data and audio data for transmission as one bit stream and of de-multiplexing a received bit stream as video data and audio data. The MUX/DEMUX 340 performs logic frame formation, serial number numbering, error detection, and error restoration through retransmission. Here, the MUX/DEMUX 340 may perform the multiplexing and de-multiplexing according to the H.223 protocol. The modem 350 modulates a bit stream into an analog signal and transmits the analog signal to the wireless communications unit 220. The modem 350 also performs the function of demodulating an analog signal received from the wireless communications unit 220 into a bit stream and transmitting the bit stream to the MUX/DEMUX 340. In an exemplary implementation, the modem 350 performs the modulation and demodulation according to the V.34 protocol.

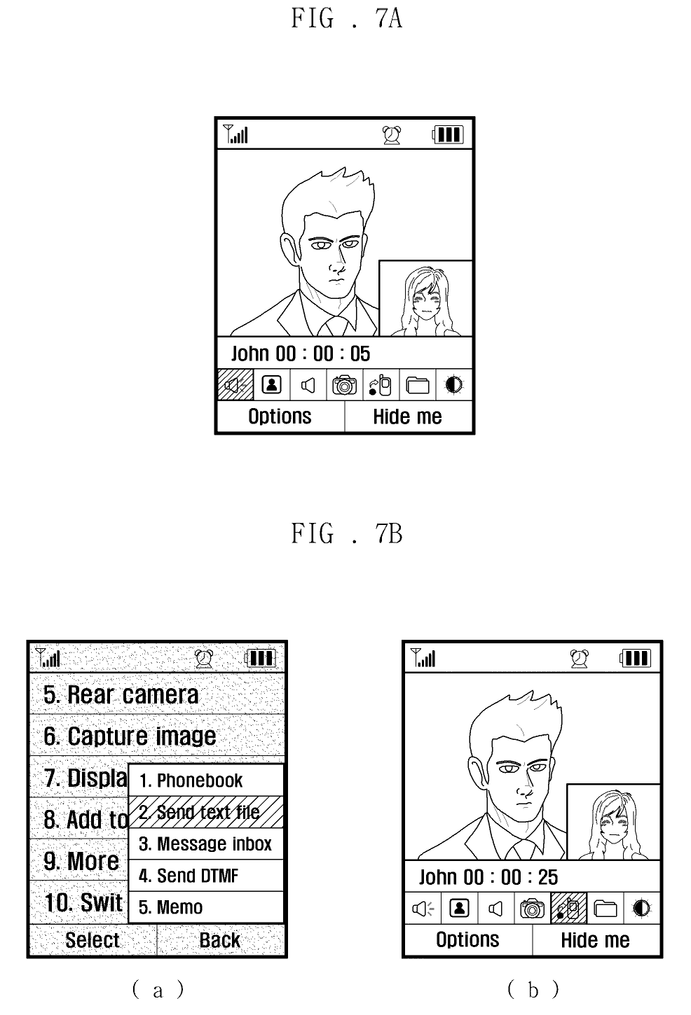

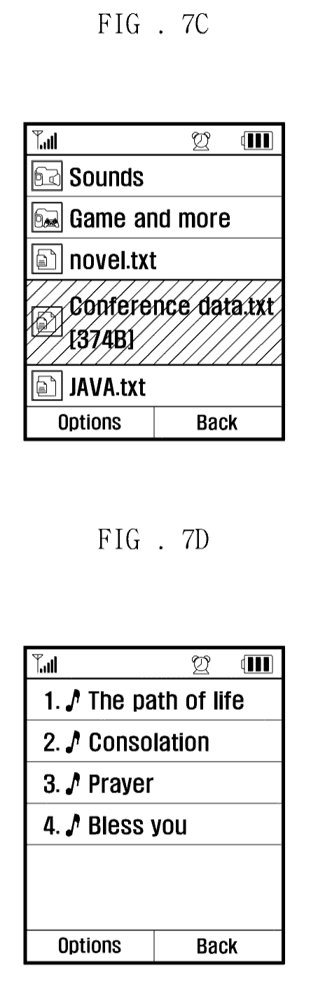

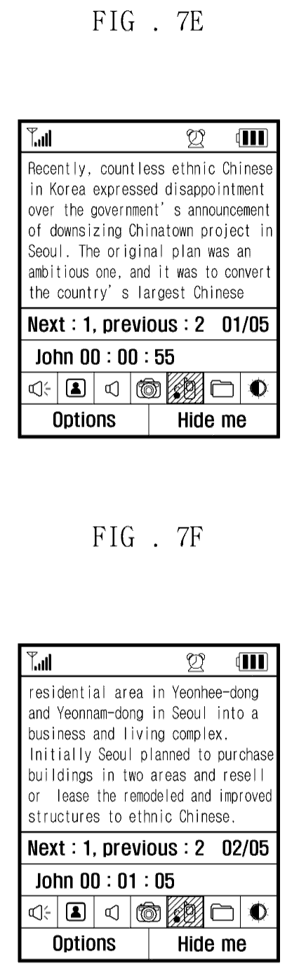

FIG. 4 is a flowchart illustrating a video telephony procedure of a communications terminal according to an exemplary embodiment of the present invention. FIGS. 7A to 7F are diagrams illustrating screens displayed during execution of a video telephony procedure according to an exemplary embodiment of the present invention. Here, FIG. 7A illustrates a screen which is displayed during video telephony, FIGS. 7B to 7D illustrate screens which are displayed when the text file transmission is required in the video telephony, and FIGS. 7E and 7F illustrate screens which are displayed when transmitting the text image during the video telephony.

Referring to FIG. 4, in a video telephony procedure according to an exemplary embodiment of the present invention, as illustrated in FIG. 7A, the controller 270 enters a video telephony mode in step 411. By entering the video telephony mode, the controller 270 is able to transmit video data. For example, the controller 270 can transmit video data photographed through the camera unit 230. Alternatively, the controller 270 can transmit video data stored in advance in the memory 260. In step 413, and as illustrated in FIGS. 7B and 7C, the controller 270 determines if a text file transmission is desired during video telephony. If it is determined that a text file transmission is desired, the controller converts a corresponding text file into a text image in step 415. For example, as illustrated in screen (a) of FIG. 7B, if a request for transmitting a text file during the video telephony is generated through a submenu, the controller 270 recognizes this request, and can display text files stored in the memory 260.

On the other hand, if a request for transmitting a text file during the video telephony is generated through a tool bar, as illustrated in screen (b) of FIG. 7B, the controller 270 recognizes this request, and can display the text files stored in the memory 260. As illustrated in FIG. 7C, if a specific text file is selected, the controller 270 recognizes this selection, and converts the selected text file into a text image. In an exemplary implementation, the controller 270 forms the text image with a form based on the H.324M protocol.

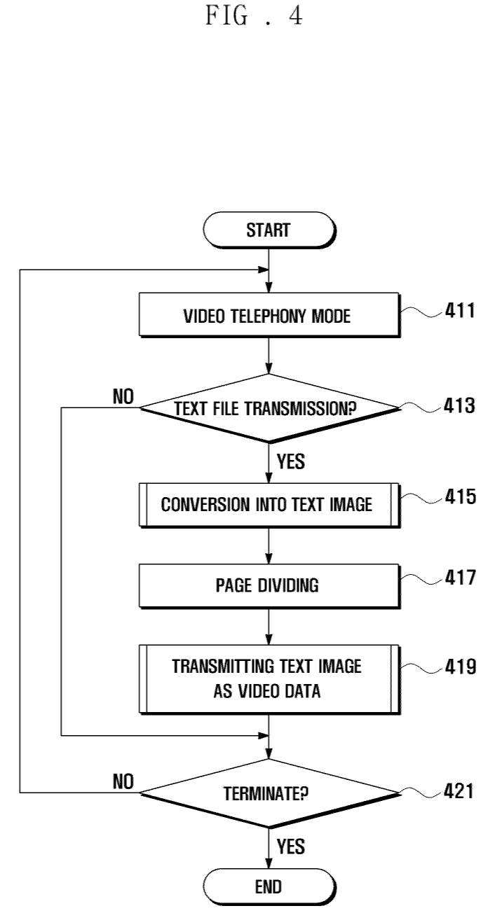

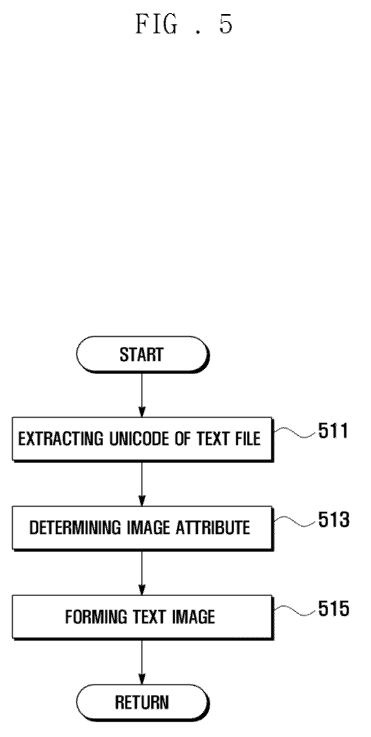

FIG. 5 is a flowchart illustrating a text image conversion procedure according to an exemplary embodiment of the present invention.

Referring to FIG. 5, when detecting that a text file is selected in step 511, the controller 270 extracts a Unicode of the text file. The Unicode is a composite of codes that are assigned to all characters, regardless of platform, program, and language, and is supported by all browsers and other products. For example, if the text file includes the text ‘HELLO’, the controller 270 extracts a Unicode of ‘ff fe 48 00 62 00 6c 00 6c 00 6f 00’ corresponding to ‘HELLO’.

In step 513, the controller 270 determines an image attribute. In an exemplary embodiment, the image attribute includes the color of the text, the background color of the text, the location of the text on the background, the coordinates of the text and the size of the text image. In an exemplary implementation, at least some of the attributes can be set as default. The controller 270 forms a text image using the Unicode and the image attribute in step 515, and returns to the process of FIG. 4. In an exemplary embodiment, the controller 270 forms the text image in such a manner that the Unicode is applied with 8-bits per pixel. In an exemplary implementation, the controller 270 can perform step 511 to step 515 by classifying a text with a certain unit in the text file. For example, as shown in FIG. 7D, in a case in which the text file includes a list of text, the controller 270 can extract ‘The path of life’ from the text file, extract the Unicode correlating to ‘The path of life’, and determine the image attribute.

Similar to the extraction of ‘The path of life’, the controller 270 subsequently extracts ‘Consolation’, ‘Prayer’ and ‘Bless you’ from the text file, extracts each correlating Unicode and determines the image attribute. Using the extracted Unicode and determined image attribute for ‘The path of life’, ‘Consolation’, ‘Prayer’ and ‘the Bless you’, the controller 270 can form a single text image. In step 417, the controller 270 may divide the text image into a number of pages. In particular, the controller 270 may divide the text image into one or more pages according to the display standard which is set at step 121 of FIG. 1. That is, if it is not possible to display the text image on a single page, the controller 270 divides the text image into two or more pages. Here, the controller 270 may divide the text image in consideration of one resolution among the display standards listed in Table 1.

TABLE 1

| display standard | Resolution |
|---|---|
| SQCIF | 128 × 96 |
| QCIF | 176 × 144 |
| CIF | 352 × 288 |
| 4CIF | 704 × 576 |
| 16CIF | 1408 × 1152 |

As illustrated in FIGS. 7E and 7F, the controller 270 transmits the text image as video data in step 419. Here, the controller 270 may transmit the text image as video data based on the H.324M protocol. At this time, if the text image includes two or more pages, the controller 270 transmits one page among the two or more pages, as illustrated in FIG. 7E. And, according to a signal received through the wireless communications unit 220, the controller 270 can transmit the other page among the two or more pages, as illustrated in FIG. 7F.

In particular, the signal received through the wireless communications unit 220 can be a Dual Tone Multi Frequency (DTMF) signal including specific key information. The key information can correspond to a next signal that indicates a request for the next page of a transmitted page, a former signal that indicates a request for the previous page of a transmitted page, or a specific page signal that indicates a request for a specific page of a transmitted image. For example, the text image may include a first page and a second page subsequent to the first page. If the controller 270 receives the next signal after transmitting the first page, it can transmit the second page. Otherwise, if the controller 270 receives the former signal after transmitting the second page, it can transmit the first page.

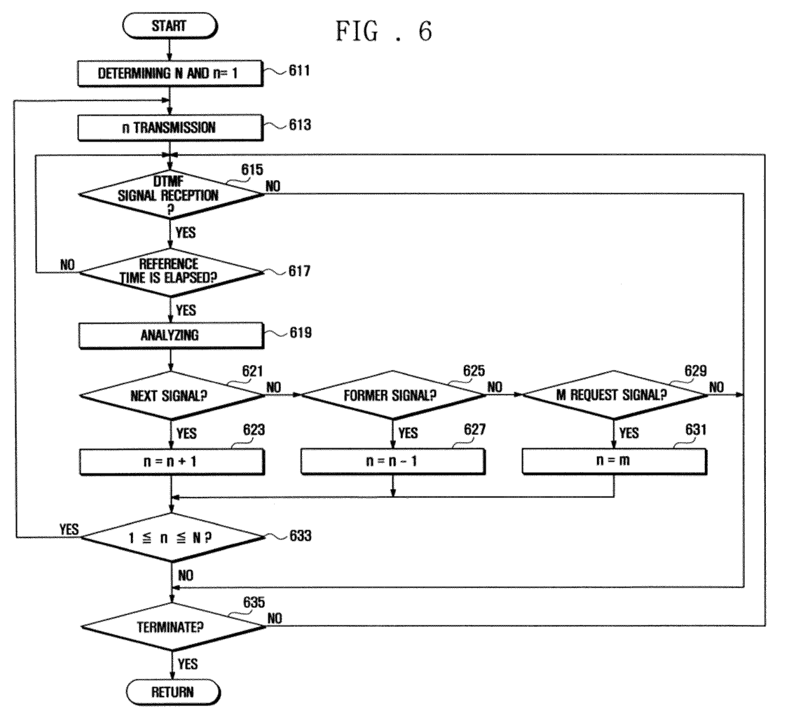

FIG. 6 is a flowchart illustrating a text image transmission procedure according to an exemplary embodiment of the present invention.

Referring to FIG. 6, in step 611, the controller 270 determines the total number of pages N of a corresponding text image when sensing the formation of the text image and sets the current page n as 1, that is, a first page. The controller 270 transmits the current page n as video data in step 613.

The controller 270 can add key information indicating a next signal, which denotes a signal requesting the next page of the current page n, key information indicating a former signal, which denotes a signal requesting the former page of the current page n, key information indicating a specific page signal, which denotes a signal requesting a specific page m of the text image and key information image for guiding page information, which may indicate the total number of pages N of a corresponding text image and a current page n, to the current page n and transmit the appropriate information. In step 615, the controller 270 determines if the DTMF signal is received and in step 617 determines whether a reference time, which may be set in advance, has elapsed since reception of the DTMF signal.

When it is determined that the reference time has not elapsed since reception of the DTMF signal, the controller 270 repeatedly performs step 615 and step 617 until the reference time has elapsed. If it is determined that the reference time has elapsed since reception of the DTMF signal at step 617, the controller 270 analyzes one or more DTMF signals received at step 619. At this time, the controller 270 extracts the key information of the one or more DTMF signal which is consecutively received within a reference time after transmitting the current page n, and combines the information. The controller 270 determines if the combination of key information corresponds to the next signal, the former signal or the selection page m signal. For example, if the key information combination of the DTMF signal which is received after transmitting the current page n is ‘1’, the controller 270 can determine the corresponding DTMF signal is a next signal. If the key information combination of the DTMF signal which is received after transmitting the current page n is ‘2’, the controller 270 can determine the corresponding DTMF signal is a former signal. If the key information combination of the DTMF signal which is received after transmitting the current page n is ‘5’ or ‘15’ for example, the controller 270 can determine the corresponding DTMF signal is a selection page m request signal, that is, a signal which requests a fifth page or a fifteenth page in a corresponding text image. If the key information combination of the DTMF signal which is received after transmitting the current page n is ‘01’, the controller 270 can determine the corresponding DTMF signal is a selection page m request signal, that is, a signal which requests a first page in a corresponding text image.

More particularly, according to the result analyzed at step 619, the controller 270 determines whether the DTMF signal is a next signal in step 621. If it is determined that the DTMF signal is a next signal at step 621, the controller 270 increases the current page n by 1 in step 623. For example, when sensing the reception of the next signal after transmitting the first page as video data, the controller 270 determines the current page n as 2, that is, a second page.

On the other hand, if it is determined that the DTMF signal is not a next signal at step 621, the controller 270 determines whether the DTMF signal is a former signal in step 625. If it is determined that the DTMF signal is a former signal at step 625, the controller 270 reduces the current page n by 1 in step 627. For example, when sensing the reception of a former signal after transmitting the second page as video data, the controller 270 determines the current page n as 1, that is, a first page.

On the other hand, if it is determined that the DTMF signal is not a former signal at step 625, the controller 270 determines whether the DTMF signal is a selection page m request signal in step 629. If it is determined that the DTMF signal is a selection page m request signal at step 629, the controller 270 sets the current page n as selection page m in step 631. For example, when sensing the reception of selection page m request signal which requests the fifteenth page after transmitting the first page as video data, the controller 270 determines the current page n as 15, that is, a fifteenth page.

In step 633, the controller 270 determines whether the current page n exists in a corresponding text image. That is, the controller 270 confirms whether the current page n is 1 or greater and corresponds to the total number of pages N or less of a corresponding text image. If it is determined that the current page n exists in a corresponding text image, the controller 270 can repeatedly perform step 613 to step 633. Otherwise, if it is determined that the current page n does not exist in a corresponding text image, the controller 270 determines whether the transmission of text image as video data should be terminated in step 635. If it is determined that the transmission of text image as video data should be terminated at step 635, the controller 270 returns to FIG. 4.

For example, when a time interval which is set without the reception of the DTMF signal has elapsed after transmitting a specific page of the text image, the controller 270 can determine that the transmission of text image as video data should be terminated. Otherwise, when a request for terminating the transmission of text image as video data is generated, the controller 270 can determine that the transmission of text image as video data should be terminated. Finally, if the request for terminating the video telephony is generated, the controller 270 recognizes this in step 421, and terminates the video telephony. On the other hand, if the request for terminating the video telephony is not recognized at step 421, the controller 270 can repeatedly perform step 411 to step 421 until the termination request is received.

In the above-described exemplary embodiments, when the communications terminal transmits the text image as video data, one page among two or more pages is transmitted, and then, the other page among the two or more pages is transmitted according to a signal received through the wireless communications unit. However, this illustrated example should not be considered limiting. That is, exemplary embodiments of the present invention can be implemented in such a manner that, in the communications terminal, after one page is transmitted among two or more pages, the other page among the two or more pages is transmitted although a signal is not received through the wireless communications unit. For example, as the time interval which is set in the communications terminal has elapsed or according to a signal generated through an input unit, the other page among two or more pages can be transmitted. According to exemplary embodiments of the present invention, the communications terminal can send and receive the text image converted from the text file as video data in the video telephony performance. That is, as the text image is received as video data, the communications terminal does not need to perform an additional operation for indicating the text file in the video telephony. Thus, the communications terminal can indicate readily the received text image. Accordingly, it is advantageous in that communications terminals can readily share the text file in the video telephony.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of performing video telephony in a communications terminal, the method comprising:
converting a selected text file into a text image when selecting the text file during video telephony; and
transmitting the text image as video data.

2. The method of claim 1, wherein the transmitting of the text image as video data comprises transmitting the text image after being divided into at least two pages.

3. The method of claim 2, wherein the text image includes a former page and a next page subsequent to the former page, and further wherein the transmitting of the text image as video data comprises:
transmitting the former page; and
transmitting the next page, upon reception of a next signal.

4. The method of claim 3, wherein the transmitting of the text image further comprises transmitting the former page upon reception of a former signal.

5. The method of claim 4, wherein the transmitting of the text image comprises transmitting a key information image indicating key information corresponding to the next signal and the former signal.

6. The method of claim 5, wherein the next signal and the former signal comprise a Dual Tone Multi Frequency (DTMF) signal.

7. The method of claim 2, wherein the transmitting of the text image comprises transmitting a required page, when receiving a selection page request signal which requests one of the at least two pages.

8. The method of claim 7, wherein the selection page request signal comprises a combination of at least one DTMF signal.

9. The method of claim 1, wherein the converting of the selected text file comprises:
extracting a Unicode of text corresponding to the selected text file;
determining an image attribute of the selected text file; and
forming the text image with the extracted Unicode and the determined image attribute.

10. The method of claim 9, wherein the image attribute comprises at least one of a color of the text in the selected text file, a background color of the text, a location of the text in the background, and a size of the text image.

11. A communications terminal comprising:
a wireless communications unit for transmitting video data during video telephony;
a controller which controls to convert a selected text file into a text image when selecting the text file during video telephony, and to transmit the text image as video data; and
a memory for storing the text file.

12. The communications terminal of claim 11, wherein the controller controls to divide the text image into at least two pages prior to transmitting the text image.

13. The communications terminal of claim 12, wherein the text image includes a former page and a next page subsequent to the former page, wherein the controller controls to transmit the former page as video data, and transmit the next page as video data upon reception of a next signal.

14. The communications terminal of claim 13, wherein the controller controls to transmit the next page as the video data, and transmit the former page as the video data upon reception of a former signal.

15. The communications terminal of claim 14, wherein, in transmitting the text image as video data, the controller controls to add key information image indicating key information corresponding to the next signal and the former signal.

16. The communications terminal of claim 15, wherein the next signal and the former signal comprise a Dual Tone Multi Frequency (DTMF) signal.

17. The communications terminal of claim 12, wherein the controller controls to transmit a required page as the video data, when receiving a selection page request signal which requests one of the pages in the video telephony.

18. The communications terminal of claim 17, wherein the selection page request signal comprises at least one DTMF signal.

19. The communications terminal of claim 11, wherein the controller controls to extract a Unicode of text corresponding to the selected text file, determines an image attribute of the selected text file, and forms the text image with the extracted Unicode and the determined image attribute.

20. The communications terminal of claim 19, wherein the image attribute comprises at least one of a color of the text in the selected text file, a background color of the text, a location of the text in the background, and a size of the text image.
